(19) United States
(12) Patent Application Publication
(10) Pub. No.: US 2013/0188929 A1
(43) Pub. Date: Jul. 25, 2013

(54) INFORMATION RECORDING APPARATUS AND METHOD

(71) Applicants: Keiji Katata, Kanagawa (JP); Takao Sawabe, Kanagawa (JP); Mutsumi Fujita, Kanagawa (JP); Yoshimi Tomita, Kanagawa (JP); Nobuyuki Takakuwa, Kanagawa (JP)

(72) Inventors: Keiji Katata, Kanagawa (JP); Takao Sawabe, Kanagawa (JP); Mutsumi Fujita, Kanagawa (JP); Yoshimi Tomita, Kanagawa (JP); Nobuyuki Takakuwa, Kanagawa (JP)

(73) Assignee: PIONEER CORPORATION, Kanagawa (JP)

(21) Appl. No.: 13/878,373

(22) PCT Filed: Oct. 12, 2010
(86) PCT No.: PCT/JP2010/067876

§ 371 Date: Apr. 8, 2013

(51) Int. Cl. H04N 9/87

(52) U.S. Cl. CPC H04N 9/87
USPC 386/248

(57) ABSTRACT

An information recording apparatus is provided with a storing device for storing one or a plurality of content data and records at least one portion of the one or plurality of content data onto a recording medium having a recordable recording layer. The information recording apparatus is provided with: a management data generating device for generating management data with reference to an application program corresponding to the at least one portion of the content data when the at least one portion of the content data is recorded onto the recording medium, the management data including information indicating the application program as specific information, the management data being data for managing reproduction of the at least one portion of the content data; and a recording device for recording the at least one portion of the content data, the application program, and the generated management data onto the recording medium.

### TECHNICAL FIELD

The present invention relates to an information recording apparatus and method for performing a recording operation on a recording medium such as, for example, a DVD and a Blu-ray Disc.

### BACKGROUND ART

In this type of apparatus, information is recorded on a recording medium in accordance with a predetermined standard. For example, patent documents 1 and 2 describe that audio visual (AV) data is recorded on a recording medium such as, for example, a Blu-ray Disc (hereinafter referred to as a “BD” as occasion demands) in accordance with a moving picture experts group-2 transport stream (MPEG-2 TS) standard. Here, in particular, a real playlist generated with a clip in one-on-one manner in recording the clip for managing an actual MPEG stream and a virtual playlist newly generated in editing existing data are discussed in detail.

Incidentally, regarding the recording medium such as a DVD and a BD at which this type of apparatus is aimed, a multilayer type recording medium in which a plurality of recording layers are laminated or stacked on a same substrate has been developed. More specifically, a multilayer type DVD-ROM or BD-ROM in which a read-only type recording layer is laminated, a multilayer type DVD-R or BD-R in which a recordable type (specifically, write-once type) recording layer is laminated, and a multilayer DVD-RW or BD-RE in which a recordable type (specifically, rewritable type) recording layer is laminated have been developed.

Moreover, a recording medium in which different types of recording layers complying with the same standard are laminated or stacked (so-called intrahybrid disc) has been also developed. As the intrahybrid disc, a recording medium in which a read-only type recording layer complying with a BD standard and a rewritable type recording layer complying with the BD standard are laminated, a recording medium in which a read-only type recording layer complying with a DVD standard and a rewritable type recording layer complying with the DVD standard are laminated, and the like are listed as one example.

### PRIOR ART DOCUMENT

Patent Document

Patent document 1: Japanese Patent Application Laid Open No. 2002-158971

Patent document 2: Japanese Patent Application Laid Open No. 2005-327453

### DISCLOSURE OF INVENTION

Subject to be Solved by the Invention

By the way, an application program for providing a user with data about a map, writing or the like related to the AV data together with at least one portion of the AV data has been under development. Here, the application program generates link information for at least one portion of the AV data by using a format unique to the application program.

As the link information, for example, a file name of a file associated with the AV data can be used. Alternatively, information associated with the application program as the link information can be registered, for example, in an editable area (e.g. attribute information, etc.) within a playlist.

However, the file name associated with the AV data is likely changed by a recording apparatus or the like when the recording apparatus or the like adds or deletes the AV data. Then, if the file name is changed, a link to at least one portion of the AV data is likely cut, which is technically problematic.

Moreover, the data stored in the editable area within the playlist is likely rewritten, for example, for the reasons of the recording apparatus or the like. Then, even in this case, there is such a technical problem that the link to at least one portion of the AV data is likely cut.

In view of the aforementioned problems, it is therefore an object of the present invention to provide an information recording apparatus and method capable of preventing that the link of the application program to at least one portion of the AV data is cut.

Means for Solving the Subject

The above object of the present invention can be achieved by an information recording apparatus, provided with a storing device for storing one or a plurality of content data, for recording at least one portion of the one or plurality of content data onto a recording medium having a recordable recording layer, the information recording apparatus provided with: a management data generating device for generating management data with reference to an application program corresponding to the at least one portion of the content data when the at least one portion of the content data is recorded onto the recording medium, the management data including information indicating the application program as specific information, the management data being data for managing reproduction of the at least one portion of the content data; and a recording device for recording the at least one portion of the content data, the application program, and the generated management data onto the recording medium.

According to the information recording apparatus of the present invention, the information recording apparatus is provided with the storing device such as a hard disk drive and a flash memory. The storing device stores therein the one or plurality of content data, for example, broadcasted by digital broadcasting. The information recording apparatus records the at least one portion of the one or plurality of content data, onto the recording medium having the recordable recording layer such as a BD-RE.

The management data generating device, which is provided, for example, with a memory, a processor and the like, generates the management data with reference to the application program corresponding to the at least one portion of the content data when the at least one portion of the content data is recorded onto the recording medium, wherein the management data includes the information indicating the application program as the specific information and the management data is the data for managing the reproduction of the at least one portion of the content data

The expression “when the at least one portion of the content data is recorded onto the recording medium” means at least one portion of a period from a time point when a user instructs the recording of the at least one portion of the content data onto the recording medium to a time point when the recording of the at least one portion of the content data onto the recording medium is completed.

The expression “the application corresponding to the at least one portion of the content data” means an application program generated on the premise of using the at least one portion of the content data. Such an application program is generated by a production company or a producer for producing the at least one portion of the content data, or a company, the individual, etc. related to the production company.

The application program may be stored in the storing device of the information recording apparatus by broadcasting it as data broadcasting coupled with the broadcasting of the at least one portion of the content data, or it may be recorded in advance on the recording medium onto which the at least one portion of the content data is to be recorded.

The “information indicating the application program” is, for example, a name of the application program, an icon image associated with the application program, an identification number of the application program, or the like.

As described above, the application program is generated on the premise of using the at least one portion of the content data. Thus, in the application program, typically, information indicating which part of the at least one portion of the content data is used is incorporated. The information recording medium generates the management data with reference to the information indicating which part is used, which is incorporated in the application program.

The recording device, which is provided, for example, with a memory, a processor and the like, records the at least one portion of the content data, the application program, and the generated management data onto the recording medium.

Particularly in the present invention, the generated management data includes the information indicating the application program as the specific information (i.e. in an unchangeable state). Thus, the recording apparatus and the user can relatively easily recognize that the content data associated with the management data is used by the application program.

Then, for example, if the recording apparatus is configured to change the management data including the information indicating the application program such that in a case where the information associated with contents used by the application program is changed, it maintains consistency with the changed information associated with contents, then, it is possible to prevent that the link of the application program to the at least one portion of the content data is unintentionally cut.

Moreover, since the user can recognize that the content data associated with the management data is used by the application program, the user deletes the content data used by the application program, thereby preventing the unintentional cut of the link of the application program to the at least one portion of the content data.

In one aspect of the information recording apparatus of the present invention, the management data generating device includes image data associated with the application program, in the management data as the information indicating the application program.

According to this aspect, when the management data is generated, the image data associated with the application program (e.g. an icon image, etc.) is included in the management data. Thus, when reproduction is performed on the recording medium on which the at least one portion of the content data is recorded, the image data associated with the application program can be displayed on a title name list displayed on a screen of a liquid crystal television, a plasma television, or the like caused by reference to the management data. As a result, the user can relatively easily recognize the content data used by the application program.

In another aspect of the information recording apparatus of the present invention, the management data generating device includes information indicating the management data generated with reference to the application program, in the management data.

According to this aspect, a recording apparatus or the like can relatively easily recognize, with reference to the management data, (i) whether or not the management data is management data generated with reference to the application program and (ii) the content data by the application program if it is the management data generated with reference to the application program.

In another aspect of the information recording apparatus of the present invention, the application program is stored in the storing device.

According to this aspect, for example, the application program is broadcasted as data broadcasting coupled with the broadcasting of the at least one portion of the content data, and it is stored into the storing device of the information recording medium.

Alternatively, in another aspect of the information recording apparatus of the present invention, the recording medium further has a read-only recording layer, and the application program is recorded in the read-only recording layer.

According to this aspect, the recording medium is a so-called intrahybrid disc, provided with the read-only recording layer and the recordable recording layer. In this case, the recording medium is typically manufactured and sold with the application program recorded in the read-only recording layer, as a recording medium only for at least one portion of the content data.

The above object of the present invention can be also achieved by an information recording method in an information recording apparatus, provided with a storing device for storing one or a plurality of content data, for recording at least one portion of the one or plurality of content data onto a recording medium having a recordable recording layer, the information recording method provided with: a management data generating process of generating management data with reference to an application program corresponding to the at least one portion of the content data when the at least one portion of the content data is recorded onto the recording medium, the management data including information indicating the application program as specific information, the management data being data for managing reproduction of the at least one portion of the content data; and a recording process of recording the at least one portion of the content data, the application program, and the generated management data onto the recording medium.

According to the information recording method of the present invention, as in the information recording apparatus of the present invention described above, it is possible to prevent that the link of the application program to the at least one portion of the content data is unintentionally cut.

Incidentally, even the information recording method of the present invention can adopt the same various aspects as those of the information recording apparatus of the present invention described above.

The operation and other advantages of the present invention will become more apparent from Mode for Carrying Out the Invention explained below.

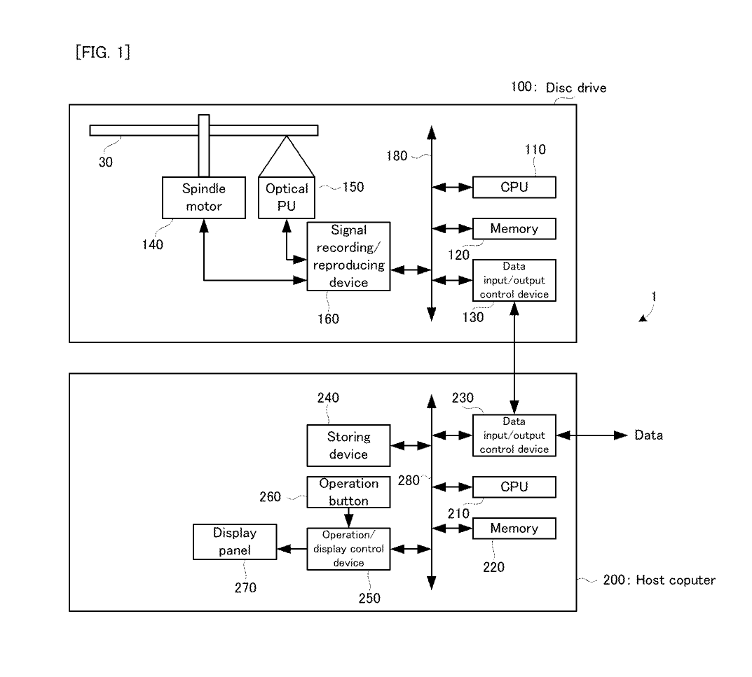

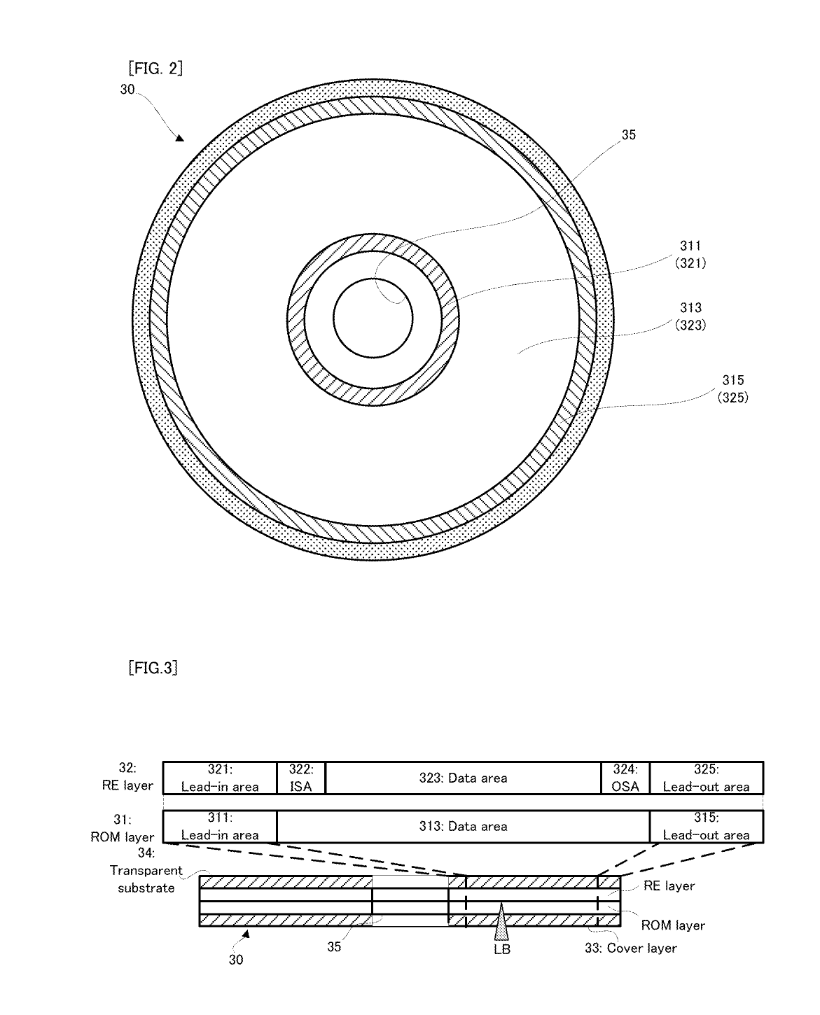

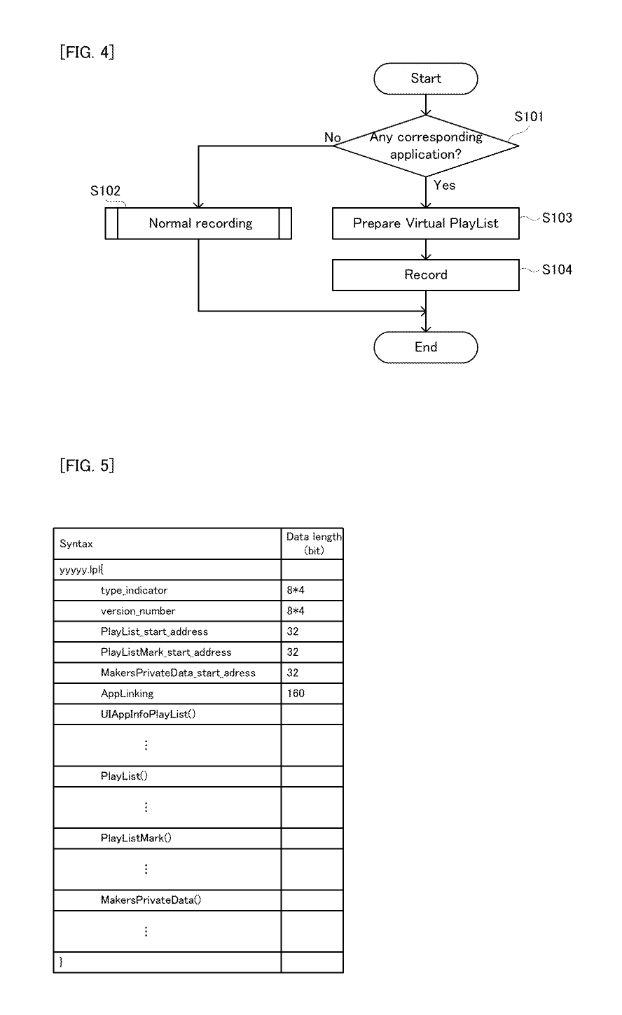

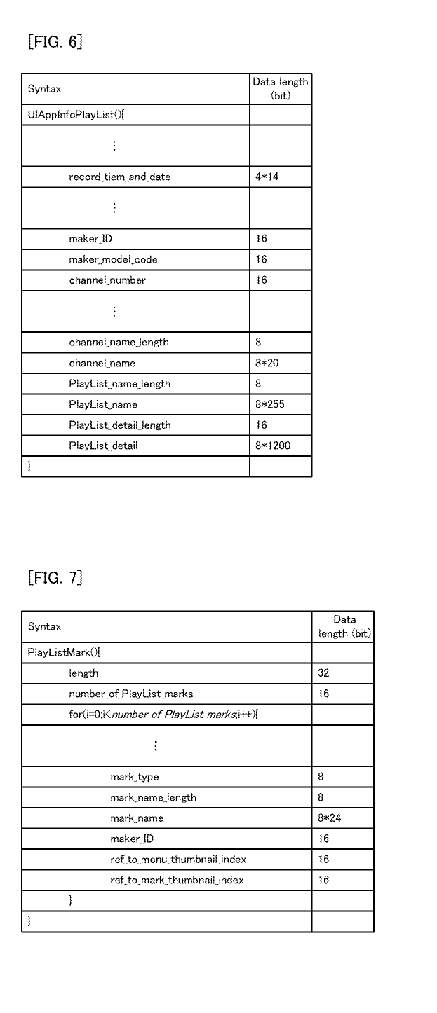

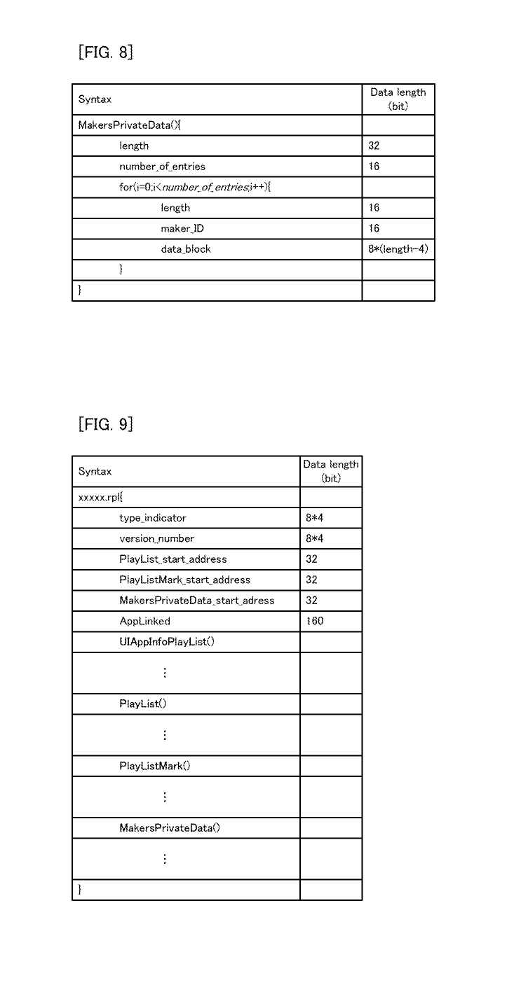

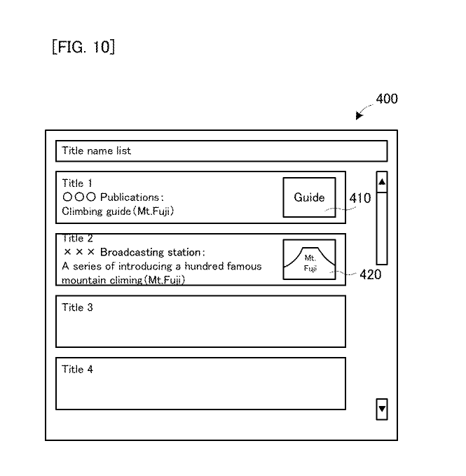

### BRIEF DESCRIPTION OF DRAWINGS

[FIG. 1] FIG. 1 is a block diagram showing the structure of a recording/reproducing apparatus in an embodiment of the present invention.

[FIG. 2] FIG. 2 is a schematic plan view showing the structure of a recording medium in the embodiment of the present invention.

[FIG. 3] FIG. 3 is a conceptual view showing the structure of recording areas in a radial direction of the recording medium in the embodiment of the present invention.

[FIG. 4] FIG. 4 is a flowchart showing a recording process performed by the recording/reproducing apparatus in the embodiment of the present invention.

[FIG. 5] FIG. 5 is a view showing one example of syntax of a Virtual PlayList.

[FIG. 6] FIG. 6 is a view showing one example of syntax of a UIAppInfoPlayList.

[FIG. 7] FIG. 7 is a view showing one example of syntax of a PlayListMark.

[FIG. 8] FIG. 8 is a view showing one example of syntax of a MakersPrivateData.

[FIG. 9] FIG. 9 is a view showing one example of syntax of a RealPlayList.

[FIG. 10] FIG. 10 is a view showing one example of a title menu list displayed on a screen.

### BEST MODE FOR CARRYING OUT THE INVENTION

Hereinafter, an embodiment of the information recording apparatus and method of the present invention will be explained with reference to the drawings. Incidentally, in an embodiment, a recording/reproducing apparatus is listed as one example of the “information recording apparatus” of the present invention.

(Configuration of Recording/Reproducing Apparatus)

Firstly, the configuration of a recording/reproducing apparatus will be explained with reference to FIG. 1. FIG. 1 is a block diagram showing the structure of the recording/reproducing apparatus in the embodiment.

In FIG. 1, a recording/reproducing apparatus 1 is provided with: a disc drive 100 on which a recording medium 30 is actually loaded and on which data recording and data reproduction are performed; and a host computer 200, such as a personal computer, for controlling the data recording and reproduction with respect to the disc drive 100.

The disc drive 100 is provided with a central processing unit (CPU) 110, a memory 120, a data input/output device 130, a spindle motor 140, an optical pickup 150, a signal recording/reproducing device 160, and a bus 180.

On the other hand, the host computer 200 is provided with a CPU 210, a memory 220, a data input/output device 230, a storing device 240, an operation/display control device 250, an operation button 260, a display panel 270, and a bus 280.

The CPU 110 is connected to the memory 120 and the signal recording/reproducing device 160 through the bus 180. The CPU 110 controls the entire disc drive 100 by giving instructions to various control devices. Normally, software or firmware for operating the CPU 110 is stored in the memory 120.

The memory 120 is used in general data processing and an optimum power control (OPC) process on the disc drive 100, such as a buffer area for record/reproduction data, an area used as an intermediate buffer when data is converted into the data that can be used on the signal recording/reproducing device 160, and the like. Moreover, the memory 120 is provided with: a ROM area in which a program for performing an operation as a recording device, i.e. firmware, is stored; a buffer for temporarily storing the record/reproduction data; a RAM area in which a variable required for the operations of the firmware program or the like is stored; and the like.

The data input/output control device 130 controls data input/output from the exterior to the disc drive 100 and stores the data into or extracts it from a data buffer on the memory 120. A drive control command issued from the exterior host computer 200 connected to the disc drive 100 through an interface such as SCSI and ATAPI is transmitted to the CPU 110 through the data input/output control device 130. Moreover, the record/reproduction data is also exchanged with the host computer 200 through the data input/output control device 130 in the same manner.

The spindle motor 140 is intended to rotate and stop the recording medium 30 and operates in accessing the recording medium 30. More specifically, the spindle motor 140 is configured to rotate the recording medium 30 at a predetermined speed and to stop it under spindle servo by a not-illustrated servo unit or the like.

The optical pickup 150 is provided, for example, with a semiconductor laser apparatus, a lens and the like in order to perform the recording/reproduction on the recording medium 30. More specifically, the optical pickup 150 irradiates the recording medium 30 with a light beam, such as a laser beam, as reading light with a first power on reproduction, and as writing light with a second power with it modulated on recording.

The signal recording/reproducing device 160 controls the spindle motor 140 and the optical pickup 150 to perform the recording/reproduction on the recording medium 30. More specifically, the signal recording/reproducing device 160 is provided, for example, with a laser diode driver (LD driver), a head amplifier and the like. The laser diode driver drives a not-illustrated semiconductor laser disposed within the optical pickup 150. The head amplifier amplifies an output signal of the optical pickup 150, i.e. reflected light of the light beam, and outputs the amplified signal.

The CPU 210 transmits a control command to the disc drive 100 through the data input/output device 230 on the basis of instruction information from the operation/display control device 250 and controls the entire disc drive 100. In the same manner, the CPU 210 can transmit to the disc drive 100 a command to require transmitting its operation state to the host. By this, since the operation state of the disc drive 100 such as during recording and during reproduction can be recognized, the CPU 210 can output the operation state of the disc drive 100 on the display panel 270 such as a liquid crystal display through the operation/display control device 250.

The memory 220 is an internal memory apparatus used by the host computer 200. The memory 220 is provided with: a ROM area in which a firmware program such as a basic input/output system (BIOS) is stored; a RAM area in which a variable required for the operations of an operating system, an application program or the like is stored; and the like.

The operation/display control device 250 performs the reception of an operation instruction and display with respect to the host computer 200. The operation/display control device 250 sends to the CPU 210 an instruction by the operation button 260 to perform the recording or reproduction.

The storing device 240 stores one or a plurality of content data broadcasted by terrestrial digital broadcasting or the like, the application program or the like broadcasted by data broadcasting, and the like which are obtained through the data input/output device 230.

The “CPU 210” in the embodiment is one example of the “management data generating device” of the present invention. The “CPU 110”, the “signal recording/reproducing device 160”, and the “CPU 210” in the embodiment are one example of the “recording device” of the present invention.

(Configuration of Recording Medium)

Next, the configuration of the recording medium 30 will be explained with reference to FIG. 2 and FIG. 3. FIG. 2 is a schematic plan view showing the structure of the recording medium in the embodiment. FIG. 3 is a conceptual view showing the structure of recording areas in a radial direction of the recording medium in the embodiment.

As shown in FIG. 2 and FIG. 3, the recording medium 30 is provided with a center hole 35 as the center, lead-in areas 311 and 321, data areas 313 and 323, and lead-out area 315 and 325, on a recording surface on a disc main body, for example, with a diameter of approximately 12 cm.

In each recording area of this recording layer, tracks such as a groove track and a land track are alternately disposed spirally or concentrically, centered on the center hole 35. Moreover, on the track, data is divided and recorded by a unit of ECC block. The ECC Block is a data management unit in which record information can be error-corrected.

In particular, the recoding medium 30 has such a structure that a ROM layer 31 and a RE layer 32 are laminated on a transparent substrate 34 and that a transparent cover layer 33 is further laminated thereon, as shown in FIG. 3. In other words, in the recording medium 30, recording layers or the like are laminated between the cover layer 33 and the transparent substrate 34.

In the recording/reproduction of such a dual-layer recording medium 30, the data reproduction is performed in the ROM layer 31 or the data recording/reproduction is performed in the RE layer 32, depending on which recording layer has the focus position of a laser beam LB irradiated from the lower side to the upper side in FIG. 3.

The ROM layer 31 is provided with the lead-in area 311, the data area 313, and the lead-out area 315 from the inner circumferential side (the left side in FIG. 3) to the outer circumferential side (the right side in FIG. 3). In the lead-in area 311, control data or management data for controlling or managing data recorded in advance in the data area 313 and other dummy data and the like are recorded in advance. In the data area 313, arbitrary data is recorded in advance. In the lead-out area 315, the control data or management data for controlling or managing the data recorded in advance in the data area 313 and the other dummy data are recorded in advance.

Incidentally, since the ROM layer 31 is a read-only type recording layer, various data is recorded in advance by using, for example, embossed pits in each of the lead-in area 311, the data area 313 and the lead-out area 315.

The RE layer 32 is provided with the lead-in area 321, an inner spare area (ISA) 322, the data area 323, an outer spare area (OSA) 324, and the lead-out area 325 from the inner circumferential side (the left side in FIG. 3) to the outer circumferential side (the right side in FIG. 3). In the lead-in area 311, control data or management data for controlling or managing data recorded in advance in the data area 313 and other dummy data and the like are recorded in advance. In the data area 313, arbitrary data is recorded in advance. In the lead-out area 315, control data or management data for controlling or managing the data recorded in advance in the data area 313 is recorded in advance.

In the lead-in area 321, control data or management data for controlling or managing data recorded in advance in the data area 323 and other dummy data and the like are recorded as occasion demands. In each of the ISA 322 and the OSA 324, defect management information for managing a defect which occurs in the data area 323 is recorded as occasion demands, or data recorded or to be recorded in an area portion in which the defect occurs is alternatively recorded. In the data area 323, arbitrary data is recorded as occasion demands. In the lead-out area 325, the control data or management data for controlling or managing the data recorded in advance in the data area 323 and the other dummy data are recorded as occasion demands.

Incidentally, since the RE layer 32 is a rewritable type recording layer, various data is recorded by using, for example, marks formed by the irradiation of the laser beam in each of the lead-in area 321, the ISA 322, the data area 323, the OSA 324 and the lead-out area 325.

In the embodiment, the recording medium 30 is preferably a recording medium in which a plurality of recording layers which comply with standards of the same family and which are of different types (i.e. intrahybrid disc). In other words, the standard the ROM layer 31 is to comply with is preferably of the same family as the standard the RE layer 32 is to comply with.

More specifically, for example, if the ROM layer 31 complies with the BD standard, it is preferable that the RE layer 32 also complies with the BD standard. In the same manner, for example, if the ROM layer 31 complies with the DVD standard, it is preferable that the RE layer 32 also complies with the DVD standard. Moreover, the same shall apply not only in the case where the layers comply with the BD standard and the DVD standard but also in a case where they comply with other standards.

Thus, hereinafter, a case where both the ROM layer 31 and the RE layer 32 comply with the BD standard will be exemplified and explained. Moreover, in the embodiment, as an example, an explanation will be given on the recording medium 30 in which each of a track path direction in the ROM layer 31 and a track path direction in the RE layer 32 is a direction from the inner circumferential side to the outer circumferential side.

Incidentally, the recording medium 30 may be a recording medium in which a plurality of recording layers which comply with standards of different families and which are of different types (i.e. interhybrid disc). Moreover, the track path direction in the ROM layer 31 may be the same as or different from the track path direction in the RE layer 32. Incidentally, the recording medium 30 shown in FIG. 2 and FIG. 3 has two recording layers (i.e. the ROM layer 31 and the RE layer 32). However, the recording layer 30 may have three or more recording layers.

The “ROM layer 31” and the “RE layer 32” in the embodiment are one example of the “read-only recording layer” and the “recordable recording layer” of the present invention, respectively.

(Recording Process)

Next, with reference to a flowchart in FIG. 4, an explanation will be given on a recording operation in a case where the content data is recorded into the RE layer 32 of the recording medium 30 on the recording/reproducing apparatus 1 as configured above.

Incidentally, it is assumed that in the ROM layer 31 of the recording medium 30, still image data such as a map and an illustration, character data such as weather information and statistical information, and the like are recorded in advance.

Incidentally, hereinafter, a case where the content data is recorded into the RE layer 32 as Blu-ray Disc Audio/Visual (BD-AV) data will be exemplified. It is assumed that the content data is broadcasted, for example, by terrestrial digital broadcasting or the like and that it is stored in the storing device 240 through the data input/output control device 230 of the recording/reproducing apparatus 1.

The CPU 210 of the host computer 200 generates a content management data file for managing the entity of a stream file, which is the content data itself, when the content data is stored into the storing device 240 and stores the content management data file into the storing device 240.

In FIG. 4, if a user operates the operation button 260 of the host computer 200, selects at least one portion of the one or plurality of content data stored in the storing device 240, and records the selected content data into the RE layer 32 of the recording medium 30, then, the CPU 210 of the host computer 200 judges whether or not there is an application program corresponding to the selected content data (step S101).

Here, the application program is a program for providing the user with the image data and the character data or the like related to the content data together with at least one portion of the content data by using the at least one portion of the content data in its operation.

If it is judged that there is no corresponding application program (the step S101: No), the CPU 210 generates a CLIP file and a real playlist from the content management data file corresponding to the selected content data.

The CPU 210 transmits the stream file, the CLIP file, and the real playlist, which correspond to the selected content data, to the disc drive 100 through the data input/output control device 230. The CPU 110 of the disc drive 100 controls the signal recording/reproducing device 160 to record the stream file and the like received through the data input/output control device 130 into the RE layer 32 of the recording medium 30 (step S102).

On the other hand, if it is judged that there is the corresponding application program (the step S101: Yes), the CPU 210 not only generates the CLIP file and the real playlist from the content management data file corresponding to the selected content data but also generates a virtual playlist file for managing the reproduction of the selected content data with reference to the corresponding application program (step S103).

According to circumstances, the CPU 110 controls the signal recording/reproducing device 160 to perform information change or the like associated with a correspondence relation between address information indicating a portion of the stream file belonging to the corresponding application program and a reproduction elapsed time in the CLIP file and to record it into the RE layer 32 of the recording medium 30. Incidentally, the corresponding application program and the address information may be stored in the storing device 240 of the host computer 200. The application program may be recorded in the ROM layer 31 of the recording medium 30.

Now, the generated virtual playlist will be explained with reference to FIG. 5 to FIG. 8. FIG. 5 is a view showing one example of syntax of a Virtual PlayList. FIG. 6 is a view showing one example of syntax of a UIAppInfoPlayList. FIG. 7 is a view showing one example of syntax of a PlayListMark. FIG. 8 is a view showing one example of syntax of a MakersPrivateData.

Particularly in the embodiment, in order to clearly demonstrate that it is a virtual playlist generated with reference to the application program (hereinafter referred to as a “linking virtual playlist” as occasion demands), a flag of “AppLinking” is newly provided. If the value of “AppLinking” is “1”, it means that the virtual playlist is a linking virtual playlist. On the other hand, if the value of “AppLinking” is “0”, it means that the virtual playlist is a normal virtual playlist.

As a method other than the flag of “AppLinking”, there are a method of setting the extension of a file to be “lpl” and a method of setting the file name of the linking virtual playlist to be any of “30000.vpl” to “99999.vpl”. Moreover, the methods may be redundantly applied.

In “maker_ID” and “maker_model_code” within “UIAppInfoPlayList()” (refer to FIG. 6), identification information about an application program vendor and identification information about an application program applied by the vendor are stored, respectively.

Moreover, in “PlayList_name_length”, “PlayList_name”, “PlayList_detail_length” and “PlayList_detail”, for example, a show name, a comment, and the like including the name of the application program are stored. Incidentally, the show name, the comment, and the like may be obtained with reference to the real playlist corresponding to the selected content data.

In “ref_to_menu_thumbnail_index” within “PlayListMark( )” (refer to FIG. 7), information indicating image data such as an icon image associated with the application program is stored. In “ref_to_mark_thumbnail_index”, information indicating a thumbnail image which symbolizes the selected content data is stored. In “maker_ID”, identification information about an application program vendor is stored.

In “maker_ID” within “MakersPrivateData()” (refer to FIG. 8), identification information about an application program vendor is stored. In “data_block”, a copy of the content of the real playlist corresponding to the selected application program is stored.

Moreover, the CPU 210 of the host computer 200 newly provides a flag of “AppLinked” for a real playlist file (here, “xxxxx.rpl”) corresponding to the content data used by the application program, and the CPU 210 sets the value of the “AppLinked” to be “1”. FIG. 9 is a view showing one example of syntax of RealPlayList.

Incidentally, the value of “AppLinked” of a normal real playlist file (i.e. in which the corresponding content data is not used by the application program) is “0”.

As a method other than the flag of “AppLinked”, there are a method of setting the file name of the real playlist file corresponding to the content data used by the application program to be any of “30000.rpl” to “99999.rpl and a method of setting the file name of the real playlist file corresponding to the content data not used by the application program to be any of “00000.rpl” to “29999.rpl”. Moreover, the methods may be redundantly applied.

Back in FIG. 4 again, the CPU 210 of the host computer 200 performs the information change or the like associated with the correspondence relation between the address of the stream file and the reproduction elapsed time, for example, in the CLIP file, with respect to the CLIP file and the real playlist corresponding to the selected content data, as in the process in the step S102.

Then, the CPU 210 transmits the stream file, the CLIP file, the real playlist, and the virtual playlist, which correspond to the selected content data, to the disc drive 100 through the data input/output control device 230. Incidentally, if the application program is stored in the storing device 240, the CPU 210 also transmits the application program to the disc drive 100 through the data input/output control device 230.

The CPU 110 of the disc drive 100 controls the signal recording/reproducing device 160 to record the stream file and the like received through the data input/output control device 130, into the RE layer 32 of the recording medium 30 (step S104)

In the embodiment (FIG. 5), the linking virtual playlist has its extension of “lpl” and the value of “AppLinking” is “1”. Thus, a recording apparatus or the like for recording new data onto the recording medium 30 can recognize that there is the linking virtual playlist. Therefore, the recording apparatus or the like can recognize the content data or the like referred to by the linking virtual playlist.

Then, the recording apparatus or the like can be configured neither to change the file name of the content data or the like referred to by the linking virtual playlist nor to delete the file. Alternatively, the recording apparatus or the like can be configured to change the content of the linking virtual playlist if changing the file name of the content data or the like referred to by the linking virtual playlist.

As a result, it is possible to prevent the link between the application program and the content data used by the application program from being cut unintentionally.

Moreover, in “PlayList_name_length”, “PlayList_name”,

“PlayList_detail_length” and “PlayList_detail” within “UIAppInfoPlayList()” the show name, the comment, and the like including the name of the application program are stored. Moreover, in “ref_to_menu_thumbnail_index” within “PlayListMark()”, the information indicating the image data such as an icon image associated with the application program is stored.

Thus, when the recording medium 30 is reproduced by a reproducing apparatus or the like, for example, as shown in FIG. 10, as a title corresponding to the linking virtual playlist, a title 1 including the name of the application program and an icon image 410 or the like associated with the application program is displayed on a screen 400.

Then, the user can recognize that the title 1 is a title corresponding to the linking virtual playlist. Then, if the user refers to the details of the title 1, the user can relatively easily recognize the content data used by the application program.

As a result, it is possible to prevent that the user's careless deletion of the content data used by the application program causes the cut of the link between the application program and the content data used by the application program.

Incidentally, as the title corresponding to the real playlist recorded on the recording medium 30, a title 2 including a thumbnail image 420 or the like for symbolizing a show name and a show is displayed on the screen 400. FIG. 10 is one example of a title menu list displayed on the screen.

If the user selects the title 1, the application program recorded in the ROM layer 31 or the RE layer 32 of the recording medium 30 is started. Specifically, for example, by starting the application program, a map of Mt. Fuji is displayed on the screen, and, for example, a picture corresponding to one point on the map is extracted from the content data used by the application program and displayed.

On the other hand, if the user selects the title 2, the content data recorded in the RE layer 32 of the recording medium 30 (here, a video footage associated with “a series of introducing a hundred famous mountain climbing (Mt. Fuji)” is reproduced.

The “linking virtual playlist” in the embodiment is one example of the “management data” of the present invention. The data stored in “maker_ID”, “maker_model_code”, “PlayList_name_length”,

“PlayList_name”,. “PlayList_detail_length”, “PlayList_detail” and “ref_to_menu_thumbnail_index” in the “linking virtual playlist” in the embodiment is one example of the “information indicating the application program” of the present invention.

The value of “AppLinking” of “1” in the “linking virtual playlist” in the embodiment is one example of the “information indicating the management data generated with reference to the application program” in the present invention.

The present invention is not limited to the aforementioned examples, but various changes may be made, if desired, without departing from the essence or spirit of the invention which can be read from the claims and the entire specification. An information recording apparatus and method, which involves such changes, is also intended to be within the technical scope of the present invention.

### DESCRIPTION OF REFERENCE CODES

1 recording/reproducing apparatus

30 recording medium

31 ROM layer

32 32 RE layer

100 disc drive

110, 210 CPU

220 memory

130, 230 data input/output control device

140 spindle motor

150 optical pickup

160 signal recording/reproducing device

180, 280 bus

200 host computer

240 storing device

250 operation/display control device

260 operation button

270 display panel

1. An information recording apparatus, comprising a storing device for storing one or a plurality of content data, for recording at least one portion of the one or plurality of content data onto a recording medium having a recordable recording layer, said information recording apparatus comprising:
a management data generating device for generating management data with reference to an application program corresponding to the at least one portion of the content data when the at least one portion of the content data is recorded onto the recording medium, the management data being data which includes information indicating the application program as specific information and which manages reproduction of the at least one portion of the content data; and
a recording device for recording the at least one portion of the content data, the application program, and the generated management data onto the recording medium.

2. The information recording apparatus according to claim 1, wherein said management data generating device includes image data associated with the application program, in the management data as the information indicating the application program.

3. The information recording apparatus according to claim 1, wherein said management data generating device includes information indicating the management data generated with reference to the application program, in the management data.

4. The information recording apparatus according to claim 1, wherein the application program is stored in the storing device.

5. The information recording apparatus according to claim 1, wherein the recording medium further has a read-only recording layer, and the application program is recorded in the read-only recording layer.

6. An information recording method in an information recording apparatus, comprising a storing device for storing one or a plurality of content data, for recording at least one portion of the one or plurality of content data onto a recording medium having a recordable recording layer, said information recording method comprising:
a management data generating process of generating management data with reference to an application program corresponding to the at least one portion of the content data when the at least one portion of the content data is recorded onto the recording medium, the management data being data which includes information indicating the application program as specific information and which manages reproduction of the at least one portion of the content data; and
a recording process of recording the at least one portion of the content data, the application program, and the generated management data onto the recording medium.
